(19) United States
(12) Patent Application Publication
(10) Pub. No.: US 2023/0298174 A1
(43) Pub. Date: Sep. 21, 2023

(54) IMAGE PROCESSING APPARATUS, IMAGE PROCESSING METHOD, AND NON-TRANSITORY COMPUTER READABLE MEDIUM

(71) Applicant: CANON KABUSHIKI KAISHA, Tokyo (JP)

(72) Inventor: Itaru OTOMARU, Kanagawa (JP)

(21) Appl. No.: 18/180,899

(22) Filed: Mar. 9, 2023

(30) Foreign Application Priority Data
Mar. 16, 2022 (JP) 2022-041125

(51) Int. Cl. G06T 7/00; G06T 15/00; G06V 10/75; G06F 3/14

(52) U.S. Cl. CPC G06T 7/0012; G06T 15/00; G06V 10/751; G06F 3/14; G06V 2201/07; G06T 2207/20081; G06T 2207/30048

(57) ABSTRACT

An image processing apparatus includes a memory storing a program, and a processor which, by executing the program, causes the image processing apparatus to acquire data including a three-dimensional image obtained by capturing an image of a subject under examination, a standard plane parameter representing a predetermined standard plane in the three-dimensional image, and an anatomical landmark position in the three-dimensional image, and acquire a vicinity cross section image defining a cross section in the vicinity of the predetermined standard plane. The processor further causes the image processing apparatus to acquire the anatomical landmark position on the vicinity cross section image, and acquire a learning model generated by using information including the vicinity cross section image and the anatomical landmark position acquired by the image processing apparatus to estimate, from the cross section image, an anatomical landmark position on the cross section image.

### BACKGROUND OF THE INVENTION

### Field of the Invention

The technology disclosed in the present application relates to an image processing apparatus, an image processing method, and a storage medium.

### Description of the Related Art

In diagnosis using medical images, it is practiced to estimate positions of predetermined anatomical landmarks (feature points) in cross section images each showing a two-dimensional cross section of a subject under examination, and measure a shape of the subject under examination on the basis of a result of the estimation or calculate various diagnostic indices.

In recent years, with the development of machine learning technologies such as deep learning, when a large amount of learning data with sufficient variations is available, anatomical landmark positions can be estimated with high accuracy. However, unlike in image processing that allows a large amount of learning data to be collected, medical images generally have a problem to be solved in that an amount of available learning data is small for variations of a subject of the medical images. For this reason, techniques of augmenting the learning data (data expansion) have been proposed.

In Japanese Patent Application Publication No. 2019-118694, a learning image is determined in advance and, while image acquisition is interactively performed using an ultrasonic probe, an image having a given or more degree of similarity to the learning image is acquired as an expanded learning image.

In Japanese Patent Application Publication No. 2008-515595, a template image for detecting nodules in a subject under examination is rotated to perform augmentation of learning data.

However, even though augmentation of the learning cross section images is performed using methods of the conventional techniques described above, due to insufficient variations of the learning data, sufficient inference performance may be still unobtainable.

### SUMMARY OF THE INVENTION

In view of the foregoing, an object of the technology disclosed in the present application is to provide a technology of improving inference performance when anatomical landmark (feature point) positions in medical images are estimated on the basis of machine learning.

According to an aspect of the present disclosure, it is provided an image processing apparatus including at least one memory storing a program, and at least one processor which, by executing the program, causes the image processing apparatus to: acquire data including a three-dimensional image obtained by capturing an image of a subject under examination, a standard plane parameter representing a predetermined standard plane in the three-dimensional image, and an anatomical landmark position in the three-dimensional image, acquire, on the basis of the standard plane parameter, a vicinity cross section image defining a cross section in the vicinity of the predetermined standard plane, acquire the anatomical landmark position on the vicinity cross section image, and acquire a learning model generated by using, as learning data, information including a pair of the vicinity cross section image and the anatomical landmark position acquired by the image processing apparatus to estimate, from the cross section image, an anatomical landmark position on the cross section image.

According to an aspect of the present disclosure, it is provided an image processing method comprising the steps of: acquiring data including a three-dimensional image obtained by capturing an image of a subject under examination, a standard plane parameter representing a predetermined standard plane in the three-dimensional image, and an anatomical landmark position in the three-dimensional image, acquiring, on the basis of the standard plane parameter, a vicinity cross section image defining a cross section in the vicinity of the predetermined standard plane, acquiring the anatomical landmark position on the vicinity cross section image, and acquiring a learning model generated by using, as learning data, information including a pair of the vicinity cross section image and the acquired anatomical landmark position to estimate, from the cross section image, an anatomical landmark position on the cross section image.

According to an aspect of the present disclosure, it is provided a non-transitory computer readable medium that stores a program, wherein the program causes a computer to execute the steps of: acquiring data including a three-dimensional image obtained by capturing an image of a subject under examination, a standard plane parameter representing a predetermined standard plane in the three-dimensional image, and an anatomical landmark position in the three-dimensional image, acquiring, on the basis of the standard plane parameter, a vicinity cross section image defining a cross section in the vicinity of the predetermined standard plane, acquiring the anatomical landmark position on the vicinity cross section image, and acquiring a learning model generated by using, as learning data, information including a pair of the vicinity cross section image and the acquired anatomical landmark position to estimate, from the cross section image, an anatomical landmark position on the cross section image.

Further features of the present invention will become apparent from the following description of exemplary embodiments with reference to the attached drawings.

### BRIEF DESCRIPTION OF THE DRAWINGS

FIG. 1 is a diagram illustrating a schematic configuration of an image processing apparatus according to an embodiment;

FIG. 2 is a flow chart of processing to be performed by the image processing apparatus according to the embodiment;

FIG. 3 is a flow chart of learning model acquisition processing to be performed by the image processing apparatus according to the embodiment;

FIGS. 4A to 4D are diagrams schematically illustrating standard planes and anatomical landmarks in the embodiment;

FIGS. 5A to 5C are diagrams schematically illustrating approximation processing for the anatomical landmarks in the embodiment;

FIG. 6 is a diagram illustrating a schematic configuration of the image processing apparatus according to the embodiment;

FIG. 7 is a flow chart of processing to be performed by the image processing apparatus according to the embodiment; and

FIG. 8 is a flow chart of processing to be performed by the image processing apparatus according to the embodiment.

### DESCRIPTION OF THE EMBODIMENTS

Referring to the drawings, a description will be given below of preferred embodiments of a technology disclosed in the present application. Note that the individual figures are intended only to explain structures or configurations, and dimensions of illustrated members do not necessarily reflect real dimensions. In addition, throughout the individual figures, the same members or the same constituent elements are denoted by the same reference signs, and a repetitive description of details will be omitted.

An image processing apparatus according to each of the embodiments described below provides a function of estimating a position of a predetermined anatomical landmark corresponding to an observation target in a predetermined standard plane for observation of the observation target in an input three-dimensional image. The input image serving as a processing target is a medical image, i.e., an image of a subject under examination (such as a human body) photographed or generated for the purpose of medical diagnosis, examination, study, or the like, which is typically an image acquired by an image capturing system referred to as modality. For example, an ultrasonic image obtained by an ultrasonic diagnostic device, an X-ray CT image obtained by an X-ray CT device, an MRI image obtained by an MRI device, or the like may be the processing target. The anatomical landmark is a characteristic point in the observation target in the image. The image processing apparatus performs data expansion (augmentation) on learning data appropriate for estimation of anatomical landmark positions in a standard plane of a three-dimensional image to generate a learning model through machine learning.

In the following description, a specific example of the image processing apparatus will be described in detail by using, as an example, a case where anatomical landmarks in a mitral valve region of a heart serving as the observation target are estimated by using, as an input three-dimensional image, a transesophageal three-dimensional ultrasonic image obtained by capturing an image of the mitral valve region. Note that using a mitral valve as the observation target is only exemplary, and another segment may also be the observation target.

### First Embodiment

An image processing apparatus according to the first embodiment estimates, from the input three-dimensional image corresponding to the input image and from a two-dimensional standard plane defined on the image, anatomical landmark positions defined in the standard plane. In addition, the image processing apparatus generates, from the learning data, the learning model that estimates the anatomical landmark positions.

The standard plane mentioned herein is a two-dimensional cross section appropriate for observation of the observation target in the three-dimensional image obtained by capturing an image of the subject under examination, which is, in the case of the present embodiment, a cross section (hereinafter referred to as the “A-plane”) that allows the mitral valve and an aortic valve in the heart to be simultaneously observed. In other words, the standard plane is a cross section including the anatomical landmarks intended to be observed. The A-plane is an example of the predetermined standard plane. Note that the standard plane may also be another plane according to the purpose of observing the observation target.

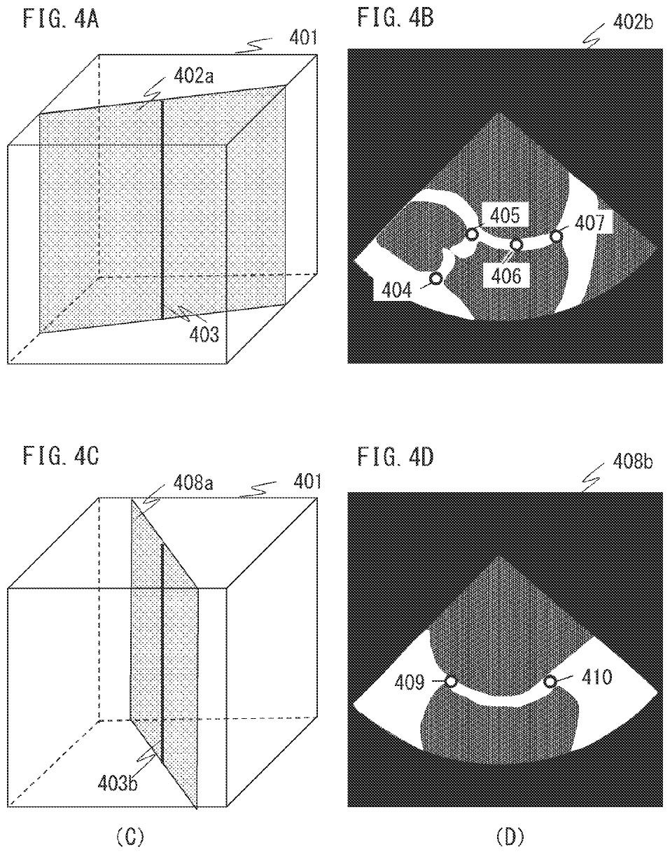

In the present embodiment, by way of example, the anatomical landmarks are four points “Ao”, “A”, “P”, and “Nadir” each included in the “A-plane”. FIGS. 4A to 4D schematically illustrate the A-plane set in the three-dimensional image and the anatomical landmarks defined in the A-plane. In FIG. 4A, a predetermined cross section (402a) cut out from a three-dimensional image (401) obtained by capturing an image of the mitral valve region is the A-plane. FIG. 4B illustrates a two-dimensional cross section image of the A-plane 402a. In FIG. 4B, an anatomical landmark 404 is Ao, an anatomical landmark 405 is A, an anatomical landmark 406 is Nadir, and an anatomical landmark 407 is P. The anatomical landmark Ao is a position at which the A-plane crosses an aortic valve ring, while the anatomical landmarks A and P are positions at which the A-plane crosses a mitral valve ring. Meanwhile, the anatomical landmark Nadir is a lowermost point of the mitral valve ring in the A-plane. Note that the anatomical landmarks the positions of which are to be estimated may also be other anatomical landmarks according to the purpose of the observation.

In the present embodiment, when augmentation of the learning data is to be performed, an image in a vicinal cross section (vicinity cross section) obtained by displacing the standard plane out of plane may also be regarded as a learning image as long as the displacement is a displacement (perturbation) equal to an inter-observer variability. On the basis of this, the image processing apparatus in the present embodiment first adds, to the standard plane, out-of-plane parallel movement and/or rotation within a predetermined range to acquire an image (vicinity cross section image) of the vicinity cross section different from the standard plane. The out-of-plane parallel movement/rotation mentioned herein refers to coordinate conversion in which, by the parallel movement/rotation, at least one of points in the standard plane is changed to a position outside the standard plane. Typical out-of-plane parallel movement/rotation is parallel movement of the standard plane in a normal direction and, in this case, all the points originally present in the standard plane are moved to positions outside the standard plane. Then, on the basis of the positions of the anatomical landmarks defined on the standard plane image, positions of the anatomical landmarks on the vicinity cross section image are acquired. Specifically, the anatomical landmarks defined on the standard plane image are projected on the vicinity cross section image. By doing so, under the constraint that the displacement (perturbation) from the standard plane falls within the predetermined range, it is possible to acquire, as the learning data, a large number of pairs of the cross section images and the anatomical landmarks. The image processing apparatus in the present embodiment performs the machine learning by using the learning data augmented in this manner to generate the learning model. Note that the present embodiment is also applicable not only to the four points described above, but also to a case where a position of any point in the standard plane is to be estimated.

In the present embodiment, it is assumed that each of the anatomical landmarks is present in the standard plane, but three-dimensional positions of the anatomical landmark on the input three-dimensional image need not necessarily be present in the standard plane. In other words, a shortest distance between the anatomical landmark and the cross section need not necessarily be 0 as long as the difference is sufficiently small to allow the anatomical landmark to be considered to lie in the cross section. In such a case also, as long as an approximate position of the anatomical landmark on the standard plane image can be defined, processing in the present embodiment can be performed without problems.

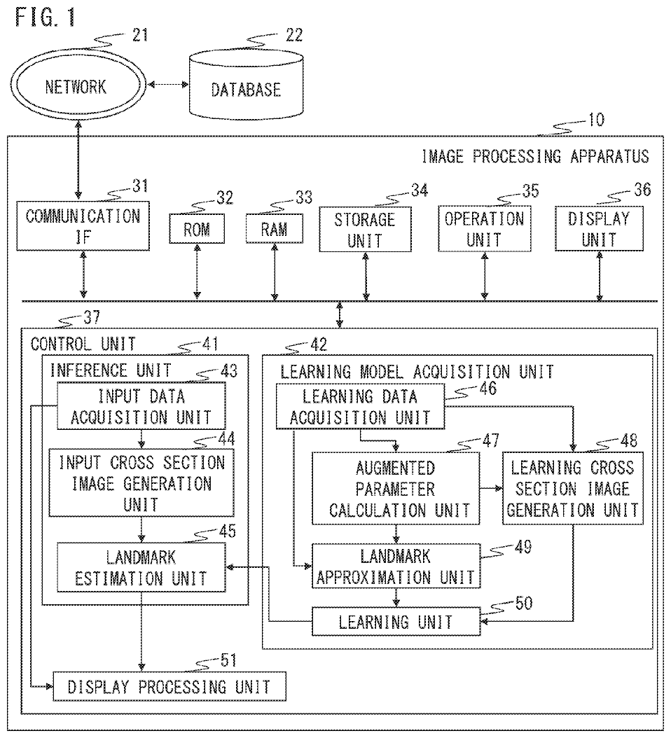

Referring to FIG. 1, a description will be given below of a configuration of the image processing apparatus and processing therein in the present embodiment. FIG. 1 is a block diagram illustrating an example of a configuration of an image processing system (referred to also as a medical image processing system) including the image processing apparatus in the present embodiment. An image processing system 1 includes an image processing apparatus 10 and a database 22. The image processing apparatus 10 is communicatively connected to the database 22 via a network 21. The network 21 includes, e.g., a LAN (Local Area Network) or a WAN (Wide Area Network).

The database 22 holds and manages a plurality of images and information to be used in processing described below. The information managed by the database 22 includes input images (processing target images) to be subjected to anatomical landmark estimation processing by the image processing apparatus 10 and the learning data for generating the learning model. Note that the information managed by the database 22 may also include information about the learning model generated from the learning data, instead of the learning data. The information about the learning model may also be stored in an inner storage (a ROM 32 or a storage unit 34) of the image processing apparatus 10, instead of the database 22. The image processing apparatus 10 can acquire the data held in the database 22 via the network 21.

The image processing apparatus 10 includes a communication IF (Interface) 31, the ROM (Read Only Memory) 32, a RAM (Random Access Memory) 33, the storage unit 34, an operation unit 35, a display unit 36, and a control unit 37.

The communication IF 31 is a communication unit configured to include a LAN card or the like and implement communication between an external device (such as, e.g., the database 22) and the image processing apparatus 10. The ROM 32 is configured to include a nonvolatile memory or the like and store various programs and various data. The RAM 33 is configured to include a volatile memory or the like, and is used as a work memory that temporarily stores a program being executed and data. The storage unit 34 is configured to include an HDD (Hard Disk Drive) or the like and store various programs and various data. The operation unit 35 is configured to include a keyboard, a mouse, a touch panel, and the like to input instructions from a user (e.g., a doctor or a laboratory technician) to various devices.

The display unit 36 is configured to include a display or the like and display various information to the user. The control unit 37 is configured to include a CPU (Central Processing Unit) or the like and perform overall control of the processing in the image processing apparatus 10. The control unit 37 includes, as a functional configuration thereof, an inference unit 41, a learning model acquisition unit 42, and a display processing unit 51. The inference unit 41 includes an input data acquisition unit 43, an input cross section image generation unit 44, and a landmark inference unit 45. The learning model acquisition unit 42 includes a learning data acquisition unit 46, an augmented parameter calculation unit 47, a learning cross section image generation unit 48, a landmark approximation unit 49, and a learning unit 50. The control unit 37 may also include a GPU (Graphics Processing Unit), a DSP (Digital Signal Processor), a FPGA (Field-Programmable Gate Array), or the like.

It may also be possible to adopt a configuration in which learning processing is performed by another apparatus other than the image processing apparatus 10, and the learning model acquisition unit 42 of the present apparatus acquires the learning model stored in the database 22 or the storage unit 34. Alternatively, the configuration may also be such that the inference unit is a separate device, and the model acquisition unit merely performs processing of generating the learning model and storing the learning model in the storage unit 34 or the database 22.

The input data acquisition unit 43 acquires, from the database 22, pairs of input images each corresponding to the processing target (images in which the positions of the anatomical landmarks are unknown) and standard plane parameters in the input images. The input images are images of the subject under examination acquired by various modalities which are, in the case of the present embodiment, three-dimensional ultrasonic images of a heart. Each of the standard plane parameters is a vector of a total of six parameters including three parameters for a center position and three parameters for a normal vector which is, in the case of the present embodiment, a parameter representing the A-plane. The input images may also be acquired directly from the modalities. In this case, the image processing apparatus 10 may also be mounted in a console of any of the modalities (image capturing system). Alternatively, the standard plane parameters may also be acquired as a result of manual setting by the user or automatically estimated on the basis of the input images.

The input cross section image generation unit 44 uses each of the input images acquired by the input data acquisition unit 43 and the standard plane parameter to generate two-dimensional cross section images by cutting out the input image by using the standard plane parameter.

The landmark inference unit 45 uses the learning model obtained by the learning model acquisition unit 42 to estimate coordinate values of the anatomical landmarks from the two-dimensional cross section images obtained by the input cross section image generation unit 44.

The learning data acquisition unit 46 acquires the learning data from the database 22. Each of samples included in the learning data includes pixel value information of a learning three-dimensional image, the standard plane parameter, and coordinate value information of the anatomical landmarks. It is assumed herein that the coordinate value information of each of the anatomical landmarks is represented by three-dimensional coordinate values and, as described previously, the anatomical landmarks include the four points referred to as Ao, A, P, and Nadir. It is assumed that all the anatomical landmarks are present in a cross section represented by the standard plane parameter and subjected to coordinate conversion to two-dimensional coordinates in the cross section, which are stored in the RAM 33.

The augmented parameter calculation unit 47 calculates, on the basis of the learning data acquired in the learning data acquisition unit 46, cross section parameters of a plurality of the vicinity cross sections for each of learning samples under the constraint that the vicinity cross sections are in the vicinity of and outside the standard plane in each of the learning samples. In other words, the augmented parameter calculation unit 47 adds the parallel movement and rotation within the predetermined range to the standard plane parameter without involving in-plane movement and in-plane rotation of the standard plane to calculate novel parameters (augmented parameters or vicinity cross section parameters).

The learning cross section image generation unit 48 uses each of the learning samples acquired in the learning data acquisition unit 46 and the augmented parameters calculated by the augmented parameter calculation unit 47 to generate the two-dimensional cross section images. In other words, for one three-dimensional image included in each of the learning samples, the two-dimensional cross section images the number of which is obtained by “adding 1 to the number of the augmented parameters” are generated. The number of the two-dimensional cross section images is larger by one than the number of the augmented parameters because the two-dimensional cross section images include the standard plane in the learning sample. Note that the cross section image generation processing by the learning cross section image generation unit 48 is the same as the cross section image generation processing performed by the input cross section image generation unit 44 except that the input data is the learning data.

The landmark approximation unit 49 uses the anatomical landmarks acquired by the learning data acquisition unit 46 and the augmented parameters calculated by the augmented parameter calculation unit 47 to approximate the positions of the anatomical landmarks in a cross section represented by the augmented parameters. The anatomical landmarks the approximate positions of which are thus calculated are subjected to coordinate conversion to two-dimensional coordinates in the cross sections. In addition, the anatomical landmarks in each of the learning samples are also converted to two-dimensional coordinates in the standard plane by the same method.

The learning unit 50 uses the two-dimensional cross section images generated in the learning cross section image generation unit 48 and the two-dimensional coordinates of the anatomical landmarks acquired in the landmark approximation unit 49 to learn (build) the learning model that estimates the two-dimensional coordinates of the anatomical landmarks from the two-dimensional cross section images.

The display processing unit 51 displays, on the basis of a result of calculation by the landmark inference unit 45, the input image and the estimated anatomical landmarks on an image display region of the display unit 36 in a display form that allows easy visual recognition by the user of the image processing apparatus 10.

Each of the components of the image processing apparatus 10 described above functions according to a computer program. For example, through reading of the computer program stored in the ROM 32, the storage unit 34, or the like and execution thereof by the control unit 37 (CPU) using the RAM 33 as a work area, the function of each of the components is implemented. Note that some or all of the functions of the components of the image processing apparatus 10 may also be implemented by using a dedicated circuit. Alternatively, functions of some of the components of the control unit 37 may also be implemented by using a cloud computer. The functions of the components of the image processing apparatus 10 or the control unit 37 may also be implemented through, e.g., data transmission/reception performed between the image processing apparatus 10 and an arithmetic apparatus located at a place different from that of the image processing apparatus 10 and communicatively connected to the image processing apparatus 10 via the network 21.

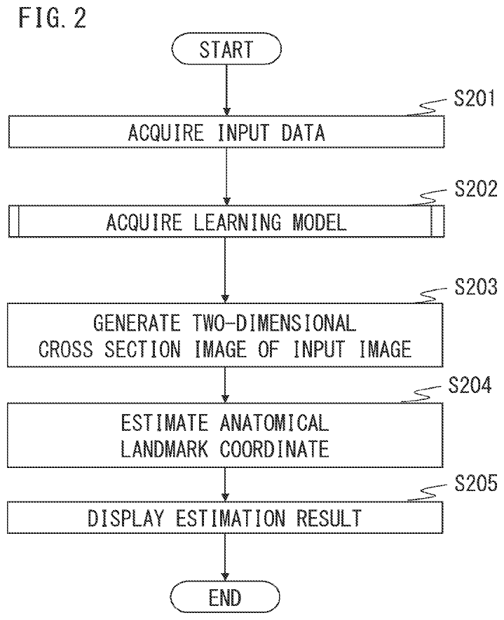

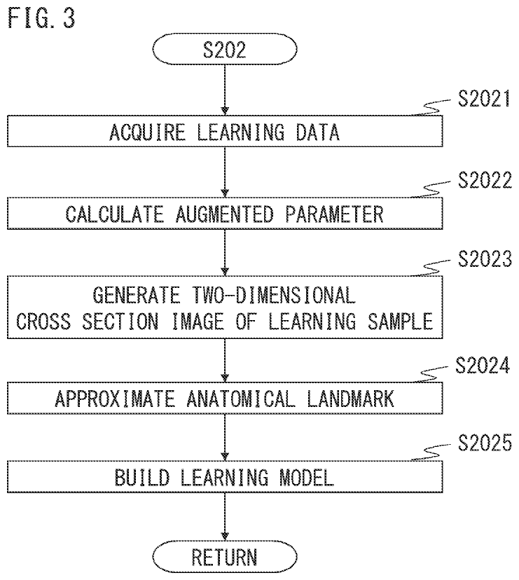

Next, using flow charts in FIGS. 2 and 3, an example of the processing in the image processing apparatus 10 in FIG. 1 will be described.

(Step S201: Acquisition of Input Data) In Step S201, the user gives an instruction to acquire an image via the operation unit 35. Then, the input data acquisition unit 43 acquires, from the database 22, a pair of the input three-dimensional image specified by the user and the input standard plane parameter representing a standard plane for the input three-dimensional image as the input data, and stores the pair in the RAM 33.

Note that, as a method of specifying the input three-dimensional image and the input standard plane parameter, any known method may be used. For example, it may be possible that the user specifies the image and manually sets the input standard plane parameter to the specified image. Alternatively, it may also be possible to automatically estimate, for the image specified by the user, the input standard plane parameter on the basis of a predetermined criterion. Still alternatively, it may also be possible to automatically select, from among a group of images specified by the user, an image satisfying a predetermined condition and automatically estimate the standard plane parameter for the selected image or receive the standard plane input by the user. Besides acquiring the input data from the database 22, it may also be possible to acquire an input image from among ultrasonic images captured from time to time by an ultrasonic image diagnostic apparatus and set the input standard plane parameter to the acquired input image. In this case also, in the same manner as in the case of acquiring the input data from the database 22, to the setting of the input standard plane parameter, either manual setting or automatic estimation is applicable.

Note that it may also be possible to adopt a configuration in which the two-dimensional cross section image is acquired as the input image corresponding to the processing target. In this case, the acquisition of the input standard plane parameter is unnecessary, and the processing in Step S203 need not be performed.

(Step S202: Acquisition of Learning Model) In Step S202, the learning model acquisition unit 42 functions as each of the learning data acquisition unit 46, the augmented parameter calculation unit 47, the learning cross section image generation unit 48, the landmark approximation unit 49, and the learning unit 50.

Using the flow chart in FIG. 3, processing in the present step will be described below in detail.

(Step S2021: Acquisition of Learning Data) In Step S2021, the learning data acquisition unit 46 acquires, from the database 22, the three-dimensional image and the standard plane parameter of each of the learning samples and the coordinate value information of the anatomical landmarks and stores, in the RAM 33, the three-dimensional image, the standard plane parameter, and the coordinate value information. As illustrated in FIG. 4B, in the present embodiment, as the anatomical landmarks, the four points referred to as Ao, A, P, and Nadir are used.

Note that, to increase robustness of the learning model, the learning data is preferably configured to include data obtained by photographing a plurality of different patients. However, images obtained by photographing the same patient at different times may also be included.

(Step S2022: Calculation of Augmented Parameters) In Step S2022, the augmented parameter calculation unit 47 calculates the plurality of cross section parameters (augmented parameters) on the basis of the standard plane parameter acquired in the learning data acquisition unit 46 under the constraint that the vicinity cross sections are in the vicinity of and outside the standard plane. In other words, the augmented parameter calculation unit 47 adds the parallel movement and rotation within the predetermined range to the standard plane parameter without involving in-plane movement and in-plane rotation of the standard plane to calculate novel parameters defining the vicinity cross sections.

In the present embodiment, on the assumption that “Translation Along Normal Vector” is the parallel movement and “Rotation Around Long Axis” is the rotation, the standard plane parameter is caused to perform the parallel movement and the rotation by these two operations to perform augmentation. The translation along the normal vector mentioned herein is the operation of causing the standard plane to perform the parallel movement in the normal direction (direction perpendicular to a paper surface) of the A-plane (FIG. 4B). Meanwhile, the rotation around the long axis is the operation of causing the A-plane to rotate around a predetermined axis extending over the standard plane, which is a long axis of the A-plane serving as a center axis (403a in FIG. 4A). Note that, in the present embodiment, a movement range of ±5 mm is set for the translation along the normal vector, while a rotation range of ±5 degrees is set for the rotation around the long axis. By randomly performing sampling a predetermined number of times (e.g., 20 times) within these ranges, the augmented parameters the number of which corresponds to the sampling number of times are obtained.

Note that, instead of randomly sampling the augmented parameters, sampling may also be performed by moving at predetermined step widths within the set movement range or rotation range. Alternatively, to avoid vias due to the random sampling, a restriction may also be set such that a distance between center positions in the augmented parameters is set to a predetermined value or more. By thus setting at least one of the parallel movement and rotational movement to movement at predetermined intervals, it is possible to obtain less biased augmented parameters.

Besides, instead of the augmentation using the rotation around the long axis shown by way of example, augmentation may also be performed using rotation around another axis such as a short axis, which is a vector perpendicular to both the long axis and the normal vector. Alternatively, it may also be possible to perform augmentation by using rotation around at least two or more axes passing through the predetermined standard plane (e.g., certain augmentation is performed using rotation around the short axis, while another augmentation is performed using rotation around the long axis). Instead of a fixed axis such as the long axis or the short axis, the rotation axis may also be dynamically changed according to the landmark positions for each of the learning samples. For example, rotation may also be caused by using, as the rotation axis, an axis passing through the predetermined landmark in the standard plane, or, rotation may also be caused around an axis obtained by connecting the landmark A (point 405 in FIG. 4B) and the landmark P (point 407 in FIG. 4B). Note that the rotation axis may also be set so as to pass through at least one landmark in the predetermined standard plane. By doing so, it is possible to take a positional relationship between the landmarks into account in the definition of the rotation axis. In addition, since the landmark positions on the rotation axis are the same as the respective positions thereof in the standard plane and on the augmented vicinity cross section images, as these landmark positions, the original landmark positions can also be used in the augmented cross section images. In other words, it is unnecessary to approximate the landmark positions. As a result, it is possible to reduce burden associated with the augmentation processing and also more accurately specify the positions of the landmarks in the vicinity cross section images.

The augmentation method is not limited to the technique described above, and may also further include a known augmentation technique implemented in typical image processing, such as parallel movement and rotation in the standard plane, enlargement/reduction, or affine transformation. Alternatively, it may also be possible to further perform augmentation that directly modifies pixel values of an image such as brightness conversion, histogram equalization, or noise addition which totally increases or reduces the pixel values. By doing so, the number of learning data sets resulting from the augmentation is further increased, and therefore it can be expected that performance of the learning model obtained in subsequent learning processing is further improved.

(Step S2023: Generation of Two-dimensional Cross Section Images of Learning Sample) In Step S2023, the learning cross section image generation unit 48 functions as a vicinity cross section image acquisition unit that acquires, on the basis of the standard plane parameter, the vicinity cross section images defining cross sections in the vicinity of the predetermined standard plane. The learning cross section image generation unit 48 uses a three-dimensional image of each of the learning samples acquired in Step S2021 and the augmented parameters calculated in Step S2022 to generate the two-dimensional cross section images (vicinity cross section images) by cutting out, from the three-dimensional image, the vicinity cross sections represented by the augmented parameters.

As described in the processing in Step S2022, for each one of the learning samples, the plurality of (e.g., twenty) augmented parameters are calculated. In processing in the present step, by using the original standard plane parameter and the augmented parameters, respective two-dimensional cross section images are generated. In other words, when the number of the augmented parameters is 20, the original standard plane parameter is added thereto to generate twenty-one two-dimensional cross section images. Accordingly, when the number of the learning samples corresponds to, e.g., 60 cases, by the processing in the present step, 21×60=1260 two-dimensional cross section images are generated.

For processing of applying the cross section parameter to the three-dimensional image to generate the two-dimensional cross section images, a known image processing technique can be used. In other words, a voxel in the original three-dimensional image to which each of pixels in each of the two-dimensional cross section images corresponding to an output destination corresponds is calculated using the cross section parameter, and a voxel value of the voxel is assigned to the pixel in the two-dimensional cross section image. Note that, when the pixel value is assigned, a known optional interpolation technique such as nearest interpolation, linear interpolation, or bicubic interpolation can be used.

(Step S2024: Approximation of Anatomical Landmarks) In Step S2024, the landmark approximation unit 49 functions as a position acquisition unit that acquires the anatomical landmark positions in the vicinity cross section images. Specifically, the landmark approximation unit 49 uses the anatomical landmarks acquired by the learning data acquisition unit 46 and the augmented parameters calculated by the augmented parameter calculation unit 47 to approximate the positions of the anatomical landmarks in the vicinity cross sections represented by the augmented parameters. The anatomical landmarks the approximate positions of which are calculated are subjected to the coordinate conversion to the two-dimensional coordinates in the vicinity cross sections. In the present step, the anatomical landmarks acquired in the learning data acquisition unit 46 are also subjected to the coordinate conversion to the two-dimensional coordinates in the standard plane.

In the present embodiment, the specification of the anatomical landmark positions on the vicinity cross section images is performed through the projection of the anatomical landmark positions in the standard plane. Specifically, lines are drawn perpendicularly from the anatomical landmarks in the standard plane to each of the vicinity cross sections, and the reached positions are regarded as the positions of the anatomical landmarks in the vicinity cross section. In other words, coordinates of feet of the perpendicular lines drawn from the anatomical landmarks in the standard plane to the vicinity cross section are assumed to be the approximate positions of the anatomical landmarks in the vicinity cross section.

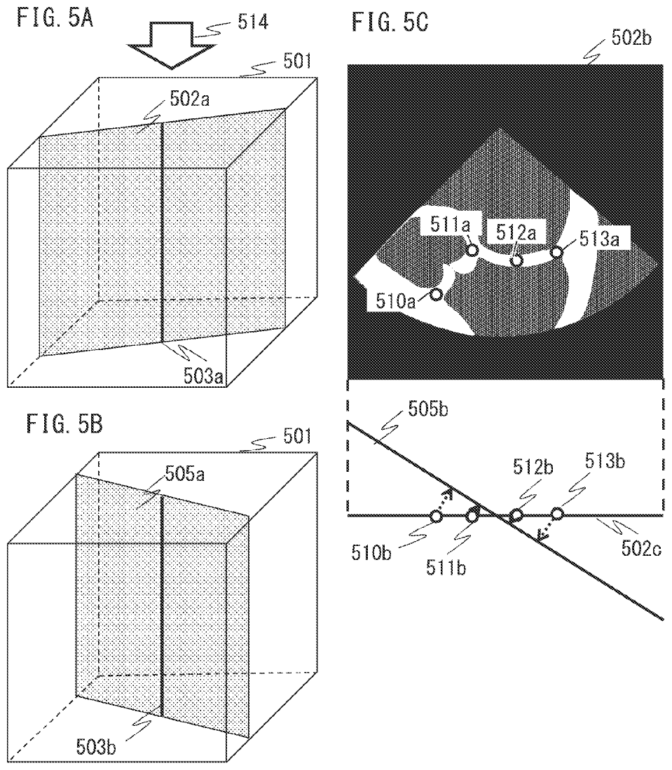

FIGS. 5A to 5C illustrate schematic diagrams of approximation processing for the anatomical landmarks. In FIG. 5A, a plane 502a represents the A-plane, while an axis 503a represents a long axis over the A-plane. Meanwhile, in FIG. 5B, a plane 505a represents the vicinity cross section obtained by rotating the A-plane by a predetermined angle around the long axis, while an axis 503b is the long axis, and corresponds to the axis 503a in FIG. 5A.

Referring to FIG. 5C, a description will be given of the approximation processing for the anatomical landmarks. An image 502b is a cross section image of the A-plane and, in the cross section, four anatomical landmarks 510a, 511a, 512a, and 513a are present. When the image 502b of the A-plane cross section is viewed in a downward direction from above (viewed in a direction indicated by an arrow 514 in FIG. 5A), the A-plane is represented as the one line segment 502c. The anatomical landmarks 510a, 511a, 512a, and 513a are represented, in the line segment 502c, as points 510b, 511b, 512b, and 513b. From this viewpoint, the proximate cross section 505a is represented as one line segment 505b inclined with respect to the A-plane 502c. At this time, the projection of the anatomical landmarks corresponds to processing of perpendicularly drawing lines from the points on the A-plane 502c to the vicinity cross section 505b like respective dotted line arrows extending from the points 510b, 511b, 512b, and 513b.

Note that the approximate positions of the anatomical landmarks can also be obtained by another approximation method instead of the projection described above. For example, the approximate positions may also be set such that the two-dimensional coordinates in the standard plane are the same as the two-dimensional coordinates in the vicinity cross section. The approximate positions can be calculated by using the parallel movement and the rotational movement each set when the augmented parameters are calculated and subjecting the anatomical landmarks to coordinate conversion. In other words, when the augmented parameters are obtained by causing, e.g., 2.5-degree rotation, for the positions of the anatomical landmarks also, the positions obtained by similarly causing 2.5-degree rotation can be used as the approximate positions. In the case of simple projection, when a rotation angle around the long axis is increased, a position to which the projection is performed is closer to the rotation axis, and consequently positions away from appropriate positions of the landmarks in the vicinity cross section may undesirably be set as the approximate positions. When the same parameters as the augmented parameters are applied, distances between the rotation axis and the anatomical landmarks are maintained, and therefore it is possible to avoid such a problem.

(Step S2025: Building of Learning Model) In Step S2025, the learning unit 50 acquires the learning model generated by using, as the learning data, information including pairs of the vicinity cross section images and the anatomical landmark positions to estimate, from the cross section images, the anatomical landmark positions on the cross section images. Specifically, the learning unit 50 uses pairs of the two-dimensional cross section images including the standard plane image and the vicinity cross section images and the two-dimensional coordinate values of the anatomical landmarks defined on the two-dimensional cross section images to learn the learning model that estimates, from the two-dimensional cross section images, the two-dimensional coordinates of the anatomical landmarks. The two-dimensional cross section images of all the learning samples including the augmented parameters that have been calculated in Step S2023 and the two-dimensional coordinates of the anatomical landmarks the approximate positions of which have been calculated in Step S2024 are input herein. Learning can use an optional known technology such as principal component analysis (PCA) or VGG16 or ResNet, which is a type of a convolutional neural network (CNN).

Thus, by the processing in Steps S2021 to Step S2025, processing of acquiring the learning model is performed (Step S202).

(Step S203: Generation of Two-dimensional Cross Section Images of Input Image) In Step S203, the input cross section image generation unit 44 functions as an input cross section image acquisition unit, and uses the input three-dimensional image acquired in Step S201 and the input standard plane parameter to generate the two-dimensional cross section images by cutting out the three-dimensional image by using the standard plane parameter. Processing of applying the standard plane parameter to the three-dimensional image to generate the two-dimensional cross section images is the same as the processing described in Step S2023.

(Step S204: Estimation of Anatomical Landmark Coordinates) In Step S204, the landmark inference unit 45 uses the learning model obtained in Step S202 to estimate the coordinate values of the anatomical landmarks from the cross section images obtained in Step S203. As described above, what is estimated by the learning model is the two-dimensional coordinate values of the anatomical landmarks in the cross section images. Accordingly, by using the standard plane parameter acquired by the input data acquisition unit 43, the two-dimensional coordinate values are subjected to coordinate conversion to the three-dimensional coordinate values. Thus, it is possible to obtain estimated values of the anatomical landmark coordinate values for the input image in which the coordinate values of the anatomical landmarks are unknown.

(Step S205: Display of Estimation Result) In Step S205, the display processing unit 51 displays, on the basis of a result of the calculation performed in Step S204, the input image and the estimated anatomical landmarks in the image display region of the display unit 36 in a display form that allows easy visual recognition.

Note that, when analysis and measurement based on the anatomical landmark positions is aimed at, the display processing in Step S205 is not mandatory, and it may also be possible to adopt a configuration which merely stores estimated anatomical landmark information in the storage device.

According to the present embodiment, in the machine learning for detecting the anatomical landmarks from the two-dimensional standard plane images, the image of the out-of-plane cross section of the standard plane is cut out from the three-dimensional image, and the landmark positions are projected to implement the augmentation. This allows the number of the learning data sets to be effectively increased and thereby allows the performance of the learning model to be improved.

### Modification 1-1

A description sill be given below of modifications of the embodiment described above. In the first embodiment, the example in which the processing target is the three-dimensional ultrasonic image obtained by capturing the image of the mitral valve region of the heart is shown, but the technology disclosed in the present application can also be implemented even in the case of using an image obtained by capturing an image of another organ other than the heart or an image provided by another modality.

As an example in which the technology disclosed in the present application is applied to an image other than that of the mitral valve region of the heart or to an image other than an ultrasonic image, a case of detecting a predetermined structure such as diencephalon or callosum from a brain MRI image can be listed. In the case of detecting such a structure, an axial cross section passing through a position at which the structure is visually recognizable serves as the standard plane, and a group of points defining a center position or profile of such a structure serve as the anatomical landmarks. Then, by the same processing as performed in the first embodiment, the positions of the anatomical landmarks are estimated.

Thus, according to the present modification, the technology disclosed in the present application can be applied also to an image from a modality other than the three-dimensional ultrasonic image.

### Modification 1-2

In the first embodiment, the example in which each of the two-dimensional cross section images cut out from the three-dimensional image by the processing in Step S203 and Step S2023 is in a plane in a space of the three-dimensional image is shown. However, the technology disclosed in the present application can also be implemented even in the case of cutting out images other than those each in a plane.

As an example of a case where images other than those each in a plane are to be cut out as the two-dimensional cross section images, a case of using a curved cross section or a free-form surface defined by a spline function or the like can be listed. In this case, the cutting out of the two-dimensional cross section images from the three-dimensional image can be performed with a known technology. Then, the curved cross section or the free-form surface is represented as a two-dimensional image developed in a two-dimensional plane. Even when the standard plane is that of such as two-dimensional developed image also, the calculation of the augmented parameters performed in Step S2022 can also be performed in the same manner as in the first embodiment, but a specific calculation method can also be implemented. For example, when the standard plane is set as a curved surface along a surface of the predetermined structure of the subject under examination, the calculation of the augmented parameters may also be performed under the constraint of being “along the surface of the predetermined structure”.

Thus, according to the present modification, the standard plane to be used for the augmentation of the learning data is not necessarily limited to a plane. As a result, even in a case where the standard plane is not a plane in the original three-dimensional image such as where, e.g., a coronary artery is developed in a two-dimensional image and observed, the technology disclosed in the present application is applicable thereto.

### Second Embodiment

Next, a description will be given of the second embodiment. Note that, in the following description, the same configurations and processing as those in the first embodiment are denoted by the same reference signs, and a detailed description thereof is omitted. In the same manner as in the first embodiment, an image processing apparatus according to the second embodiment is an apparatus that estimates the anatomical landmarks defined in the standard plane from the input three-dimensional image and the two-dimensional standard planes defined on the image. In the first embodiment, the standard plane is one (only the A-plane). However, even in a case where the standard plane includes two or more planes, the technology disclosed in the present application is applicable thereto. In the present embodiment, by way of example, a description will be given of a case where a three-dimensional ultrasonic image obtained by capturing an image of the mitral valve region is used as the target in the same manner as in the first embodiment, and a B-plane which is a cross section perpendicular to the A-plane is also used as the standard plane in addition to the A-plane.

FIGS. 4C and 4D illustrate schematic diagrams of the B-plane. As illustrated in FIG. 4C, the B-plane is the cross section crossing the A-plane (FIG. 4A) along a long axis 403b and perpendicular to the A-plane. Meanwhile, as illustrated in FIG. 4D, the two-point anatomical landmarks are present in the B-plane, and the positions of these landmarks are positions at which the B-plane crosses the mitral valve ring. In the figure, a point 409 represents a point AL, while a point 410 represents a point PM.

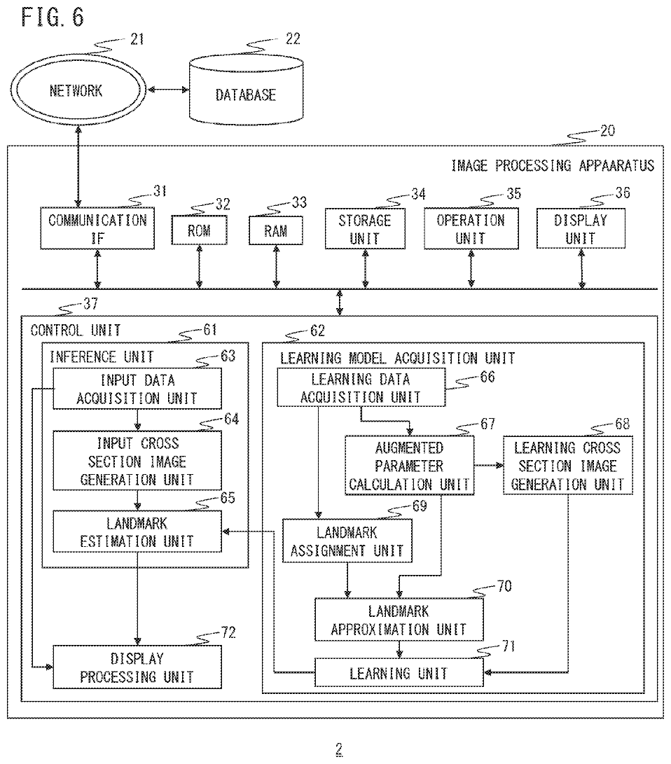

Next, referring to FIG. 6, a configuration of and processing in an image processing system 2 in the present embodiment will be described. Compared to an apparatus configuration diagram in the first embodiment illustrated in FIG. 1, to an image processing apparatus 20 of the image processing system 2, a landmark assignment unit 69 is added. In addition, due the increase of the number of the standard planes from 1 to 2, details of processing in each of the other processing units are changed from those in the first embodiment. A description will be given below of the details of the processing in each of the processing units.

Processing in an input data acquisition unit 63 and in a learning data acquisition unit 66 is the same as that in the input data acquisition unit 43 and in the learning data acquisition unit 46 in the first embodiment except that the acquired standard plane parameters are those for the two cross sections that are the A-plane and the B-plane.

Processing in an input cross section image generation unit 64 is the same as the processing in the input cross section image generation unit 44 in the first embodiment, but is different therefrom in that a label that allows the generated cross section image to be identified as being in either the A-plane or the B-plane is added, and the label is held as a pair with the cross section image.

Processing in a landmark inference unit 65 is the same as the processing in the landmark inference unit 45 in the first embodiment. However, the present embodiment is different from the first embodiment in that there are the two standard planes that are the A-plane and the B-plane. Accordingly, in response to independent building of the learning models for the A-plane and the B-plane in the learning model acquisition unit 62, the estimation of the anatomical landmarks is also independently performed.

Processing in an augmented parameter calculation unit 67 is the same as the processing in the augmented parameter calculation unit 47 in the first embodiment, but is different therefrom in that the augmented parameters for the two cross sections that are the A-plane and the B-plane are calculated.

Processing in a learning cross section image generation unit 68 is the same as the processing in the learning cross section image generation unit 48 in the first embodiment, but is different therefrom in that a label that allows the generated cross section image to be identified as being in either the vicinity cross section augmented from the A-plane or the vicinity cross section augmented from the B-plane is added, and the label is held as a pair with the cross section image.

The landmark assignment unit 69 identifies on which one of the standard plane of the A-plane and the reference section of the B-plane each of the anatomical landmarks acquired by the learning data acquisition unit 66 is located, and assigns the label of either the A-plane or the B-plane to the landmark.

Processing in a landmark approximation unit 70 is the same as the processing in the landmark approximation unit 49 in the first embodiment, but is different therefrom in that the landmark approximation unit 70 refers to a result of the assignment by the landmark assignment unit 69 and projects the anatomical landmarks assigned to the A-plane on the vicinity cross sections augmented from the A-plane, while projecting the anatomical landmarks assigned to the B-plane on the vicinity cross sections augmented from the B-surface.

Processing in a learning unit 71 is the same as the processing in the learning unit 50 in the first embodiment, but is different therefrom in that, while the standard plane is only the A-plane and one in the first embodiment, the two standard planes that are the A-plane and the B-plane are present in the present embodiment. In the present embodiment, learning of the two cross sections is performed independently of each other.

Processing in a display processing unit 72 is the same as the processing in the display processing unit 51 in the first embodiment, but is different from the first embodiment in that the number of the standard planes, which are the A-plane and the B-plane, is 2, and display processing is according to each of the A-plane and the B-plane.

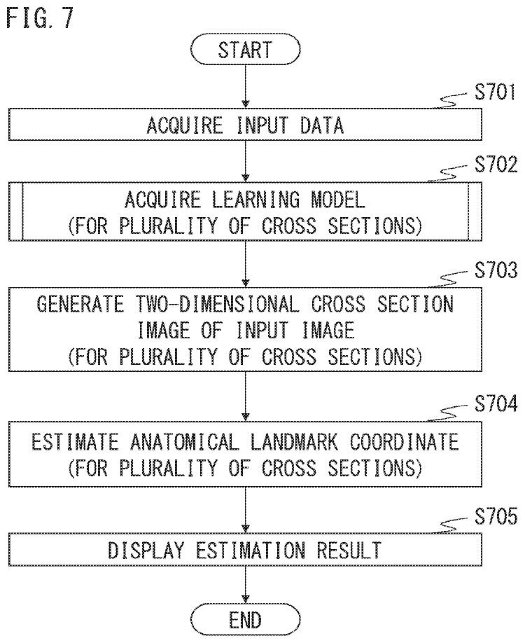

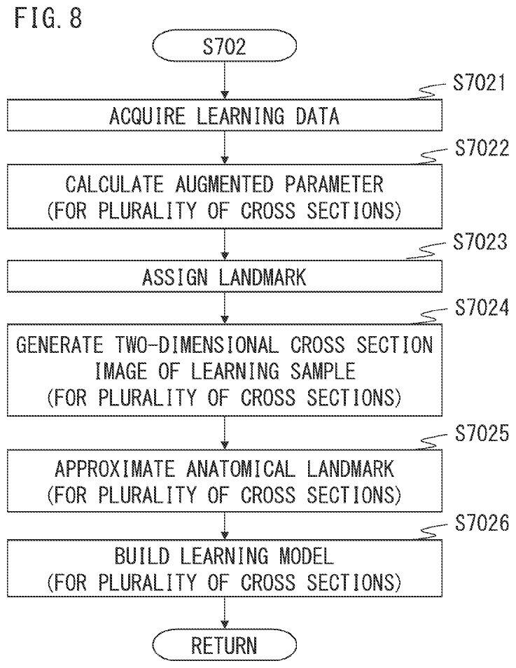

Next, referring to flow charts in FIGS. 7 and 8, an example of processing in the image processing apparatus 20 in FIG. 6 will be described.

(Step S701: Acquisition of Input Data) Processing in Step S701 is the same as the processing in Step S201 in the first embodiment except that the acquired standard plane parameters represent each of the two standard planes that are the A-plane and the B-plane.

(Step S702: Acquisition of Learning Model (for Plurality of Cross Sections)) In Step S702, the learning model acquisition unit 62 functions as each of the learning data acquisition unit 66, the augmented parameter calculation unit 67, the learning cross section image generation unit 68, the landmark assignment unit 69, the landmark approximation unit 70, and the learning unit 71. Then, the learning model acquisition unit 62 builds the learning model from the learning data acquired from the database 22.

The acquisition of the learning model is performed with respect to each of the two standard planes that are the A-plane and the B-plane. Referring to the flow chart in FIG. 8, a description will be given below of details of processing in the present step.

(Step S7021: Acquisition of Learning Data) Processing in Step S7021 is the same as the processing in Step S2021 in the first embodiment except that the acquired standard plane parameters represent the two respective standard planes that are the A-plane and the B-plane.

(Step S7022: Calculation of Augmented Parameters (for Plurality of Cross Sections)) Processing in Step S7022 is the same as the processing in Step S2022 in the first embodiment except that the augmented parameters are calculated for the two standard planes that the A-plane and the B-plane. To each of the parameters augmented by the processing in the present step, a label for identifying from which one of the A-plane and the B-plane the parameter has been augmented, and the label is held as a pair with the augmented parameter.

(Step S7023: Assignment of Landmarks) In Step S7023, the landmark assignment unit 69 identifies on which one of the standard planes that are the A-plane and the B-plane, each of the anatomical landmarks acquired by the learning data acquisition unit 66 is located, and assigns the label of either of the A-plane and the B-plane to the anatomical landmark. Note that a destination to which one of the anatomical landmarks (e.g., the point Ao) is to be assigned is required to be the same plane (A-plane or B-plane) throughout all the learning data cases.

As illustrated in FIGS. 4B and 4D, in the present embodiment, to which one of the standard planes each one of the anatomical landmarks is to be assigned is determined in advance. In other words, each of the landmark Ao (point 404), the landmark A (point 405), the landmark Nadir (point 406), and the landmark P (point 407) is assigned to the A-plane. Meanwhile, each of the landmark PM (point 409) and the landmark AL (point 410) is assigned to the B-plane. In the present step, the assignment described above is directly applied to the assignment of the labels.

Note that, even when to which one of the standard planes each one of the anatomical landmarks is to be assigned is not determined in advance also, the processing in the present step can be performed. In this case, cost of the assignment to each of the standard planes is calculated in each of the learning data sets, and the standard plane having minimum average cost in all the cases is determined to be the destination to which each of the anatomical landmarks is to be assigned. Examples of the assignment cost that can be listed herein include a distance from each of the anatomical landmarks to each of the standard planes. Alternatively, it may also be possible to use, as the assignment cost, a contrast of an image around a projection position when each of the anatomical landmarks is projected on each of the standard planes. In this case, as the contrast is higher (i.e., the possibility of presence in the vicinity of an edge is higher), it is determined that the assignment cost is lower. By doing so, even when the learning data does not hold information about to which one of the cross sections each one of the anatomical landmarks is to be assigned, it is possible to perform the processing in the present embodiment.

(Step S7024: Generation of Two-dimensional Cross Section Images in Learning Samples (for Plurality of Cross Sections)) Processing in Step S7024 is the same as the processing in Step S2024 in the first embodiment except that a label that allows the vicinity cross section derived from the A-plane or the vicinity cross section derived from the B-plane to be identified is assigned to each of the generated two-dimensional cross section images.

(Step S7025: Approximation of Anatomical Landmarks (for Plurality of Cross Sections)) Processing in Step S7025 is the same as the processing in Step S2024 in the first embodiment except that, referring to an assignment result calculated in Step S7023, each of the anatomical landmarks is projected on the vicinity cross section augmented from the standard plane serving as the assignment destination thereof. In other words, each of the anatomical landmarks assigned to the A-plane is projected on the vicinity cross section augmented from the A-plane, while each of the anatomical landmarks assigned to the B-plane is projected on the vicinity cross section augmented from the B-plane.

(Step S7026: Building of Learning Models (for Plurality of Cross Sections)) Processing in Step S7026 is the same as the processing in Step S7025 in the first embodiment except that there are the two standard planes that are the A-plane and the B-plane.

In the processing in the present step, learning of the A-plane is performed independently of learning of the B-plane. In other words, the learning model for the A-plane is built using, as the learning data, the standard plane/vicinity cross sections/anatomical landmarks to which the label indicating the A-plane is assigned. Meanwhile, the learning model for the B-plane is built using, as the learning data, the standard plane/vicinity cross sections/anatomical landmarks to which the label indicating the B-plane is assigned.

Note that the building of the A-plane and the building of the B-plane may also be performed so as to share a part of a learning process, instead of being performed completely independently. For example, it is possible to use multi-task learning in a convolutional neural network (CNN). In this case, a weight is shared up to a convolutional layer of the CNN and, to a stage subsequent thereto, a fully connected layer that estimates the anatomical landmarks in the A-plane and a fully connected layer that estimates the anatomical landmarks in the B-plane are independently connected. Besides, it is also possible to define each of the A-plane and the B-plane as a channel for the input image, and configure each of the learning models as the CNN having a multi-channel. By doing so, “Image Features Specific to Heart Ultrasonic Images” present in both of the A-plane and the B-plane are simultaneously learned for the A-plane and the B-plane, and therefore it can be expected that the built learning models will more accurately capture the features of the image.

Thus, by the processing in Steps S7021 to S7026, processing of acquiring the learning models (Step S702) is performed.

(Step S703: Generation of Two-dimensional Cross Section Images of Input Image (for Plurality of Cross Sections)) Processing in Step S703 is the same as the processing in Step S203 in the first embodiment except that, to each of the generated two-dimensional cross section images, a label for identifying whether the cross section is the A-plane or the B-plane is assigned.

(Step S704: Estimation of Anatomical Landmark Coordinates (for Plurality of Cross Sections)) Processing in Step S704 is the same as the processing in Step S204 in the first embodiment except that estimation of the anatomical landmark coordinates is performed for each of the two two-dimensional cross section images in the A-plane and the B-plane. By the processing in the present step, the anatomical landmarks in each of the A-plane and the B-plane are estimated.

(Step S705: Display of Estimation Result) In Step S705, the display processing unit 72 displays, on the basis of a result of the calculation performed in Step S704, the input image and the estimated anatomical landmarks in the image display region of the display unit 36 in a display form that allows easy visual recognition by the user of the image processing apparatus 20.

In the display form, the two-dimensional cross section images in the A-plane and the B-plane are displayed side by side as schematically illustrated in, e.g., FIGS. 4B and 4D, and circles or points are drawn thereon at the anatomical landmark positions thereon. Besides, any display form can be used as long as the user can easily visually recognize the results of estimating the anatomical landmarks.

According to the present embodiment, even when the number of the standard planes is not one, but plural, it is possible to build the learning model that estimates the positions of the anatomical landmarks present in any standard plane.

Note that, in the present embodiment, by way of example, the case where the number of the standard planes is 2 has been described, but it is possible to similarly implement the processing in the present embodiment even when the number of the standard planes is 3 or more. For example, even when there is a plane (C-plane) perpendicular to both of the A-plane and the B-plane in addition to the A-plane and the B-plane or when there is a standard plane parallel to any of these A-plane, B-plane, and C-plane, it is possible to determine the destinations to which the anatomical landmarks are to be assigned by the processing in Step S7023 and similarly perform the processing. In addition, in the present embodiment, by way of example, the case where the standard planes are perpendicular to each other has been described but, even when the cross sections are not perpendicular to each other, it is possible to similarly perform the processing in the present embodiment.

### Third Embodiment

Next, a description will be given of the third embodiment. Note that, in the following description, the same configurations and processing as those in the first and second embodiments are denoted by the same reference signs, and a detailed description thereof is omitted. In the same manner as in the first embodiment, an image processing apparatus according to the third embodiment is an apparatus that estimates the anatomical landmark positions defined in the standard plane from the input three-dimensional image and the two-dimensional standard planes defined on the image. In the first embodiment, as illustrated in FIG. 5C, the anatomical landmarks in the standard plane are projected in the augmented vicinity cross sections to augment the anatomical landmarks. However, the method of approximating the landmarks is not limited this technique, and can also be implemented by estimating (or correcting) the landmark positions in the vicinity cross sections on the basis of, e.g., various image processing technologies.

An apparatus configuration of an image processing apparatus and a processing flow chart according to the present embodiment are the same as those in the first embodiment. However, processing of approximating the landmarks (Step S2024) is different. The following will describe differences from the first embodiment.

(Step S2024: Approximation of Landmarks) In the present embodiment, by using pattern matching as processing of approximating the landmarks to be performed by the landmark approximation unit 49, positions in the vicinity cross sections corresponding to the anatomical landmarks in the standard plane are determined.

A description will be given of specific processing to be performed by the landmark approximation unit 49. First, using the standard plane image calculated in Step S2023, square regions of predetermined sizes using the respective positions of the anatomical landmarks as centers thereof are determined. These are referred to as templates. By performing matching using the templates with respect to the individual vicinity cross section images calculated in Step S2023, respective positions of the templates in the vicinity cross section images are calculated. Each of the positions thus obtained is the approximate position of each of the anatomical landmarks.

At this time, it may also be possible to limit a search range for the template matching on the basis of the position of each of the anatomical landmarks in the standard plane. For example, it may also be possible to define the approximate position of the landmark determined by the method shown in the first embodiment as an initial value of the approximate position, and perform the template matching within the predetermined search range around the initial value serving as the center thereof. This can reduce the possibility that other feature points are erroneously recognized as the landmarks. When appropriate approximate positions are not found in the template matching, it may also be possible to adopt the initial value as the approximate position. The present processing corresponds to processing of correcting the approximate position of the landmark obtained by the method shown in the first embodiment by using image information. Accordingly, the landmark approximation unit 49 functions as a position correction unit, and uses the anatomical landmark positions specified by the template matching using the cross section image of the standard plane to correct the anatomical landmark positions in the plurality of vicinity cross section images.

Note that each of the templates may also be a three-dimensional image, not the two-dimensional image. In other words, each of the templates may also be a cubic type template including pixel values on front and back sides of the standard plane. Alternatively, each of the templates may also be a spherical or ellipsoidal type template using the landmark position in the standard plane as a center thereof. In this case, the template matching is also performed in a three-dimensional space considering the respective pixels values on the front and back sides of the vicinity cross section images. When the template matching is to be performed, it may also be possible to consider a positional relationship with another anatomical landmark. For example, it may also be possible to have, as a regularization term, a distance value between the anatomical landmark of concern and each of the remaining anatomical landmarks and inhibit the distance value from be significantly changed (i.e., changed to such a degree as to allow the positional relationship between the anatomical landmarks to conceivably break down). By doing so, it is possible to increase accuracy of the template matching.

It may also be possible to determine whether or not a position appropriate as the approximate position of each of the anatomical landmarks is present in one of the vicinity cross section images (i.e., whether or not the anatomical landmark is lost), and separate the processing in the present step into cases depending on a result of the determination. In this case, when a position having a degree of similarity equal to or more than a given degree is not found in the template matching, it is determined that the landmark is lost in the vicinity cross section image. Then, when it is determined that the landmark is lost, the vicinity cross section is not adopted (is excluded from the subsequent processing). By doing so, it is possible to exclude, from the learning data, the inappropriate vicinity cross section in which the anatomical landmark is unclear, and therefore improve the quality of the learning data. Alternatively, it may also be possible to determine the positions of the anatomical landmarks in the vicinity cross sections independently of the positions of the anatomical landmarks in the standard plane image instead of excluding the vicinity cross section. In this case, the position of the anatomical landmark in the standard plane that is determined to be lost is determined such that, e.g., a relative positional relationship between the plurality of anatomical landmarks is the same as a relative positional relationship therebetween in the standard plane. In addition, only when it is determined that all the anatomical landmarks are lost, the vicinity cross section is excluded. By doing so, it is possible to minimize the vicinity cross sections to be excluded.

Besides, it is also possible to perform registration between the standard plane image and each of the vicinity cross section images and thereby approximate the landmarks. By performing the registration, a deformation field representing a correspondence relationship between the images is calculated. This deformation field is an example of a correspondence relationship between pixels representing to which position in the vicinity cross section image a specific position in the standard plane image corresponds. Then, by using this deformation field, the anatomical landmarks on the standard plane image may also be subjected to coordinate conversion to the vicinity cross section image. For the registration, various known technologies such as a technique of repetitively optimizing the degree of image similarity as cost and a technique based on machine learning can be used. For a representation form of the distortion field also, any known technology such as a rotation matrix, an affine matrix, or FFD (Free form deformation) can be used.

According to the present embodiment, the approximate positions of the anatomical landmarks in the vicinity cross section images can be calculated on the basis of the image information of the standard plane image and the vicinity cross section images. As a result, even when, e.g., a shape of the subject under examination observed in the cross sections greatly differs between the standard plane and the vicinity cross sections, and appropriate anatomical landmark approximate positions cannot be calculated by projection, an effect of allowing appropriate approximation to be performed can be expected.

### Fourth Embodiment

Next, a description will be given of the fourth embodiment. Note that, in the following description, the same configurations and processing as those in the first to third embodiments are denoted by the same reference signs, and a detailed description thereof is omitted. In the same manner as in the first embodiment, an image processing apparatus according to the fourth embodiment is an apparatus that estimates the positions of the anatomical landmarks defined in the standard plane from the input three-dimensional image and the two-dimensional standard plane images cut out of the image. In the first embodiment, when the learning model is built in Step S2025, no particular selection is made, and all the learning data sets generated in the processing up to the previous stage are used. However, a method of building the learning model is not limited to this method. For example, it is also possible to display a result of the augmentation to the user, acquire an instruction indicating a result of determining whether or not to adopt the augmentation result from the user, and use the learning data set of the augmentation result determined to be adopted to build the learning model.

An apparatus configuration of the image processing apparatus 10 and a flow chart according to the present embodiment are the same as those in the first embodiment. However, the processing of building the learning model (Step S2025) is different. The following will describe differences from the processing in the first embodiment.

(Step S2025: Building of Learning Model) In Step S2025, the image processing apparatus 10 controls the display processing unit 72 to perform display processing for the user to check the augmented cross sections (vicinity cross sections). Then, the user inputs a result of determining whether or not the user adopts the augmentation result displayed by the operation unit 35, and the image processing apparatus 10 receives the input. Then, the image processing apparatus 10 uses the standard plane and only the vicinity cross section determined to be adopted to build the learning model. Processing of building the learning model is the same as that in Step S2025 in the first embodiment.

For example, processing associated with the display of the augmentation result and the acquisition of the result of the determination by the user can be performed as follows. First, the display processing unit 72 performs display processing for the cross section images in which the vicinity cross section images are sequentially switched and displayed in the display unit 36 in response to a mouse wheel operation performed on the operation unit 35 by the user. At this time, the display processing unit 72 displays the standard plane image serving as an augmentation source in a display region of the display unit 36 aligned with a display region thereof for the vicinity cross section images. On each of the cross section images, the anatomical landmarks projected on the vicinity cross section images by the processing in Step S2023 are also displayed. The user compares a reference plane image and the vicinity cross section image each displayed on the display unit 36 to each other to determine whether or not the vicinity cross section image can be adopted as the learning data. The user operates the operation unit 35 to press, e.g., an “OK” or “NG” button on a screen with a mouse and thereby input the determination result. Alternatively, it may also be possible to adopt a configuration in which an operation of determining “OK” or “NG” is assigned to a specific key of a keyboard, and the user presses the key of the keyboard to input the determination result.

Note that, in Step S2025, the user may not only determine adoption or no adoption of the learning data, but also correct the anatomical landmark positions on the vicinity cross section images. In this case, when determining that the positions of the anatomical landmarks on the vicinity cross section images are inappropriate, the user drags the landmarks with, e.g., the mouse to correct the positions of the landmarks.

According to the present embodiment, it is possible to make a selection from among the learning data sets by relying on the result of the determination by the user, instead of using all the augmented learning data sets generated by the image processing apparatus 10 to build the learning model. This can exclude, from the learning data sets, the vicinity cross section image inappropriate as the learning data set, and consequently improved accuracy of estimation of the anatomical landmarks can be expected.

### Modification 4-1

A description will be given below of a modification of the fourth embodiment. In the fourth embodiment, whether or not to adopt the learning data as the augmented parameters is determined on the basis of the result of the determination by the user, but the determination may also be automatically made. For example, when a random cross section parameter is generated in the vicinity the standard plane and a degree of similarity between the resulting two-dimensional cross section image and the standard plane is equal to or more than a predetermined value, the cross section parameter may also be adopted as the augmented parameters. In addition, when it is determined whether or not to adopt the learning data as the augmented parameters, weighing based on a distance from the standard plane may also be used instead of relying only on the degree of similarity between the cross section images.

Besides, it is also possible to combine the automatic determination described in the present modification with the manual determination by the user described in Step S2025 in the fourth embodiment. In this case, it may also be possible that, e.g., the image processing apparatus 10 presents, to the user, only the cross section parameter automatically determined not to be adopted, and final determination of whether or not to adopt the augmented parameter is made by an operation by the user described above.

By doing so, it is possible to improve performance of the learning model, while reducing labor of the user resulting from the manual determination by the user.

While the present embodiments have been described heretofore, the technology disclosed in the present application is not limited thereto, and can be changed/modified within a scope of the technical idea of the technology disclosed in the present application. In addition, the individual embodiments and modification described above may also be combined appropriately with each other to be implemented.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The disclosed technology can be embodied as, e.g., a system, an apparatus, a method, a program, a recording medium (storage medium), or the like. Specifically, the disclosed technology may be applied to a system configured to include a plurality of devices (such as, e.g., a host computer, an interface device, an image capturing device, and a web application), or may also be applied to an apparatus including one device.

Needless to say, the object of the present invention is attained by following a procedure as shown below. In other words, a recording medium (or a storage medium) recording thereon a program code (a computer program) that can implement the functions of the above-mentioned embodiments is supplied to the system or apparatus. Needless to say, such a storage medium is a computer readable storage medium. Then, a computer (or a CPU or MPU) of the system or apparatus reads out and executes the program code stored on the storage medium. In this case, the program code read out of the recording medium implements the functions of the above-mentioned embodiments, and the recording medium recording thereon the program code constitutes the present invention.

The technology disclosed in the present application can improve estimation performance when estimation of anatomical landmarks (feature points) in a medical image is performed on the basis of machine learning.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-041125, filed on Mar. 16, 2022, which is hereby incorporated by reference herein in its entirety.

What is claimed is:

1. An image processing apparatus comprising:
at least one memory storing a program; and
at least one processor which, by executing the program, causes the image processing apparatus to:
acquire data including a three-dimensional image obtained by capturing an image of a subject under examination, a standard plane parameter representing a predetermined standard plane in the three-dimensional image, and an anatomical landmark position in the three-dimensional image;
acquire, on the basis of the standard plane parameter, a vicinity cross section image defining a cross section in the vicinity of the predetermined standard plane;
acquire the anatomical landmark position on the vicinity cross section image; and
acquire a learning model generated by using, as learning data, information including a pair of the vicinity cross section image and the anatomical landmark position acquired by the image processing apparatus to estimate, from the cross section image, an anatomical landmark position on the cross section image.

2. The image processing apparatus according to claim 1,
wherein the at least one processor causes the image processing apparatus to:
acquire, on the basis of the standard plane parameter, a plurality of the vicinity cross section images defining a plurality of the cross sections in the vicinity of the predetermined standard plane; and
acquire the anatomical landmark position in each of the plurality of vicinity cross section images.

3. The image processing apparatus according to claim 1,
wherein the vicinity cross section image is a cross section image defining a cross section outside the predetermined standard plane.

4. The image processing apparatus according to claim 1,
wherein the at least one processor causes the image processing apparatus to:
project the anatomical landmark position acquired by the image processing apparatus on the vicinity cross section image to acquire the anatomical landmark position on the vicinity cross section image.

5. The image processing apparatus according to claim 1,
wherein the at least one processor causes the image processing apparatus to:
acquire a plurality of the vicinity cross section images by causing at least one movement which is either parallel movement or rotational movement of the predetermined standard plane; and
approximate the anatomical landmark position acquired by the image processing apparatus on the basis of the at least one movement to a position on the vicinity cross section image to thereby acquire the anatomical landmark position on each of the plurality of vicinity cross section images.

6. The image processing apparatus according to claim 5,
wherein the parallel movement is parallel movement to the outside of the predetermined standard plane, while the rotational movement is rotational movement around a predetermined axis extending over the predetermined standard plane.

7. The image processing apparatus according to claim 6,
wherein the predetermined axis is an axis passing through the at least one anatomical landmark in the predetermined standard plane.

8. The image processing apparatus according to claim 6,
wherein the predetermined axis includes at least two or more axes passing through the predetermined standard plane, and
wherein the at least one processor causes the image processing apparatus to select either or any one of the two or more axes for each rotational movement.

9. The image processing apparatus according to claim 4,
wherein the at least one movement is movement at a predetermined interval.

10. The image processing apparatus according to claim 1,
wherein the at least one processor further causes the image processing apparatus to:
acquire an input three-dimensional image and an input standard plane parameter representing a predetermined standard plane on the input three-dimensional image;
acquire an input cross section image based on each of the input three-dimensional image and the input standard plane parameter; and
estimate an anatomical landmark position on the input cross section image by using the learning model acquired by the image processing apparatus.

11. The image processing apparatus according to claim 1,
wherein the predetermined standard plane includes at least two or more standard planes,
wherein the at least one processor further causes the image processing apparatus to:
assign the anatomical landmark position to either or any one of the at least two or more standard planes,
wherein the data acquired by the image processing apparatus includes the anatomical landmark position assigned by the image processing apparatus, and
wherein the at least one processor causes the image processing apparatus to:
acquire the learning model by using, as the learning data, a pair of a cross section image representing a cross section in the vicinity of the standard plane and a position based on the anatomical landmark position assigned by the image processing apparatus.

12. The image processing apparatus according to claim 1,
wherein the at least one processor causes the image processing apparatus to:
specify an anatomical landmark position on the vicinity cross section image corresponding to an anatomical landmark position on a cross section image of the predetermined standard plane on the basis of a correspondence relationship between a pixel on the cross section image of the predetermined standard plane and a pixel on the vicinity cross section image to acquire the anatomical landmark position on the vicinity cross section image.

13. The image processing apparatus according to claim 12,
wherein the at least one processor further causes the image processing apparatus to:
correct the anatomical landmark position on the vicinity cross section image by using an anatomical landmark position specified by template matching using a template determined on the basis of the predetermined standard plane by using, as a basis, the anatomical landmark position acquired by the image processing apparatus.

14. The image processing apparatus according to claim 13,
wherein the at least one processor causes the image processing apparatus to:
exclude, from the learning data, the vicinity cross section image for which the anatomical landmark position on the vicinity cross section image corresponding to the anatomical landmark position on the cross section image of the predetermined standard plane cannot be specified in the template matching.

15. The image processing apparatus according to claim 1,
wherein the at least one processor further causes the image processing apparatus to:
display, on a display unit, the vicinity cross section image acquired by the image processing apparatus; and
acquire a result of determination of whether or not the vicinity cross section image displayed on the display unit is to be adopted as the learning data, and
wherein the at least one processor causes the image processing apparatus to:
exclude, from the learning result, the vicinity cross section image shown in the determination result as the vicinity cross section image not to be adopted as the learning data.

16. An image processing method comprising the steps of:
acquiring data including a three-dimensional image obtained by capturing an image of a subject under examination, a standard plane parameter representing a predetermined standard plane in the three-dimensional image, and an anatomical landmark position in the three-dimensional image;
acquiring, on the basis of the standard plane parameter, a vicinity cross section image defining a cross section in the vicinity of the predetermined standard plane;
acquiring the anatomical landmark position on the vicinity cross section image; and
acquiring a learning model generated by using, as learning data, information including a pair of the vicinity cross section image and the acquired anatomical landmark position to estimate, from the cross section image, an anatomical landmark position on the cross section image.

17. A non-transitory computer readable medium that stores a program, wherein the program causes a computer to execute the steps of:
acquiring data including a three-dimensional image obtained by capturing an image of a subject under examination, a standard plane parameter representing a predetermined standard plane in the three-dimensional image, and an anatomical landmark position in the three-dimensional image;
acquiring, on the basis of the standard plane parameter, a vicinity cross section image defining a cross section in the vicinity of the predetermined standard plane;
acquiring the anatomical landmark position on the vicinity cross section image; and
acquiring a learning model generated by using, as learning data, information including a pair of the vicinity cross section image and the acquired anatomical landmark position to estimate, from the cross section image, an anatomical landmark position on the cross section image.
